(19) United States
(12) Patent Application Publication
(10) Pub. No.: US 2010/0205523 A1
(43) Pub. Date: Aug. 12, 2010

(54) Web Widget for Enabling Screen Reader Accessibility for a Web Application

(75) Inventors: Ondrej Lehota, Portsmouth (GB); Jeremy Rodgers, Boca Raton, FL (US); Jon Gerard Temple, Southbury, CT (US); Michael William Ticknor, Covington, KY (US)

Correspondence Address: CAHN & SAMUELS, LLP, 1100 17th STREET, NW, SUITE 401, WASHINGTON, DC, 20036, US

(73) Assignee: International Business Machines Corporation, Armonk, NY (US)

(21) Appl. No.: 12/368,133

(22) Filed: Feb. 9, 2009

(51) Int. Cl. G06F 3/048; G06F 17/00; G06F 3/01

(52) U.S. Cl. 715/235; 715/765; 715/760

(57) ABSTRACT

An embodiment of the invention provides a system for increasing accessibility of a web application to a screen reader. The system includes a screen reader connected to a web browser, wherein the web browser has a document object model (DOM). At least one web application is accessible by the web browser. At least one accessibility widget, from a widget library, is provided to modify the DOM of the web browser. The system further includes user profile information stored in the web application indicating special accessibility needs for controlling activation of the accessibility widget. A cookie is also provided for controlling activation of the accessibility widget. The accessibility widget is operable with all server platforms allowing access with a web browser.

### I. FIELD OF THE INVENTION

The present invention is in the field of methods, computer program products, and apparatuses for a web widget for enabling accessibility for a web application (e.g., for use with a screen reader, or other accessibility applications).

### II. BACKGROUND OF THE INVENTION

Many common web applications do not properly adhere to accessibility guidelines or accepted coding practices that are required for a web application to be used with a screen reader (e.g., JAWS). Some common examples include missing “ALT” tags for images, inadequate use of the “Label” tag for screen elements (such as dropdown menus), and the lack of devices to skip over static page elements (such as a masthead or navigational tabs) and directly interact with the main content area of the web page. This is particularly problematic with many vendor applications, for which the developers may have limited or no ability to alter the inaccessible code which the vended application generates. In the best of cases, a blind or other visually impaired user may need to configure their screen reader in a special way for a particular web application in order to use it. Even after such configuration, it may nevertheless take several times longer to complete an end user task than sighted user (i.e., a user with little or no visual impairments). In other cases, the blind user will be unable to complete the task at all without external help or through alternative means.

Many large vendor provided web applications, such as SAP ENTERPRISE PORTAL, may not be easily used with a screen reader. Short of rewriting a web application to use accepted screen reader accessible coding practices (an extremely expensive proposition should the vendor be willing to comply) there is no known solution to remedy the problem short of developing “separate but equal” solutions. That is, deploying completely alternative means of completing the task (such as calling the Help Desk, or using a VRU). Failure to make the web application work properly with a screen reader has the potential to disenfranchise millions of blind or low vision end users.

### III. SUMMARY OF THE INVENTION

At least one embodiment of the invention provides a system for increasing accessibility of a web application to a screen reader. The system includes a screen reader connected to a web browser, wherein the web browser has a document object model (DOM). At least one web application is accessible by the web browser. At least one accessibility widget, from a widget library, is provided to modify the DOM of the web browser.

The system further includes user profile information stored in the web application indicating special accessibility needs for controlling activation of the accessibility widget. A cookie is also provided for controlling activation of the accessibility widget. The accessibility widget is operable with all server platforms allowing access with a web browser.

At least one embodiment of the invention provides a method for increasing accessibility of a web application to an accessibility application (e.g., screen reader). More specifically, the method accesses at least one web application with a web browser connected to a screen reader. The method activates, from the web application, at least one accessibility widget from a widget library. For example, the activation of the accessibility widget is controlled by a cookie and/or user profile information stored in the web application indicating special accessibility needs. In another example, the accessibility widget is activated in response to manual selection of a link, by the screen reader user, that is only viewable using the screen reader.

The method modifies, by the accessibility widget, a document object model (DOM) of the web browser to produce a modified DOM. Modifying the DOM includes, for example, adding objects to the DOM, removing objects in the DOM, and/or modifying properties of objects in the DOM. The objects in the DOM include standard and non-standard objects identified in hypertext markup language (HTML) or extensible markup language (XML) specifications. The standard and non-standard objects include a link, anchor, image, table, caption, button, input, span, division tag, label, head, body, meta, title, paragraph, unordered lists (ul), ordered lists (ol), list items (li), form, heading, and/or extensible metadata platform (XMP).

In another example, the modifying of the DOM includes: modifying HTML attributes (e.g., ALT tags of images) within the web application using pre-configured values or values in title tags, assigning null ALT tags to images within the web application that lack the ALT tags, adding titles readable by the screen reader to frames of the web application, and/or labeling form elements of the web application. In yet another example, the modifying of the DOM includes: replacing malfunctioning screen elements with equivalent screen elements that are accessible with or without the screen reader, adding a skip-to-main-content link, adding cascading style sheets (CSS) adapted to improve accessibility of the screen reader, removing visually hidden objects that impede efficacy of the screen reader, adding table summaries and/or captions, and/or adding anchors and pointers to visually-grouped objects that are not comprehensible by the screen reader user. The modification of the DOM removes the requirement of maintaining a separate version of the web application and/or maintaining a separate version of web pages.

The activating of the accessibility widget renders the web application usable and accessible by the screen reader user while unaffecting users not requiring the screen reader. The modified DOM is output to the screen reader user and/or a rendered web page (for use by the screen reader user). The method also dynamically updates at least a portion of the modified DOM, and in response to the updating, repeats the modifying of the DOM.

### IV. BRIEF DESCRIPTION OF THE DRAWINGS

The present invention is described with reference to the accompanying drawings. In the drawings, like reference numbers indicate identical or functionally similar elements.

FIG. 1 is a schematic diagram illustrating a system for enabling screen reader accessibility for a web application according to an embodiment of the invention;

FIG. 2 is a flow diagram illustrating a method for enabling screen reader accessibility for a web application according to an embodiment of the invention; and

FIG. 3 illustrates a computer program product according to one embodiment of the invention.

### V. DETAILED DESCRIPTION OF THE DRAWINGS

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

A method according to one embodiment of the invention provides a JavaScript call to a widget library (a collection of files written primarily in JavaScript) that is embedded in a web application. This single call is sufficient to invoke a new web widget (also referred to herein as “accessibility widget”) that dynamically fixes accessibility problems in the web page, executing directly in the client web browser. The accessibility widget does not require any modifications to vendor codes other than to invoke the widget library. Once the web accessibility widget has been executed, a blind user will be able to use a screen reader with all previously inaccessible screen elements targeted by the widget for remediation.

After invoking the accessibility widget, a blind or low vision user is able to complete tasks which they may have otherwise not have been able to complete without active assistance, or at the very least, have taken significantly longer to complete. Moreover, the widget also eliminates the need to for application-specific settings in the screen reader.

The following illustrative HTML fragment, inserted at the top level of a web application, enables the accessibility widget in at least one embodiment of the invention:

```
<script type=“text/javascript”
      language=“javascript”
      src=“**Widget library config URL goes here**”>
</script>
```

This single call is sufficient to invoke the accessibility widget.

The accessibility widget dynamically fixes accessibility problems with the web page by making deletions and additions directly within the Document Object Model (DOM) of the web browser. For example, in at least one embodiment of the invention, the accessibility widget gives ‘Null’ ALT tags to images with no ALT tags, adds a “Skip to main content” link, and/or gives meaningful labels to frames. This is accomplished by manipulating the DOM resident in memory by parsing, and applying any additions, deletions, or modifications to the objects directly in the DOM. These modifications to the DOM improve the accessibility of the rendered web page when used with a web browser, screen reader or other accessibility applications. More individualized modifications are also possible, such as providing a dropdown menu with a meaningful label, replacing misbehaving screen elements with altered equivalents that work for both sighted users and those using screen readers, and loading any closed source software (CSS) developed to improve accessibility for custom applications along with the accessibility widget, to enhance its capabilities.

The accessibility widget can be activated in a variety of ways. Examples include the following ways. First, the widget can be activated for all users when the page loads. Second, the widget can be activated based on the presence of a cookie or stored user profile information indicating special accessibility needs. Thus, a cookie could be set to eliminate the need for the user to manually select the link in the future. Third, a hidden link could be provided on the page positioned in such a way that it is visible to screen readers but not visible to sighted users (e.g., CSS absolute positioning outside of the normal screen boundaries).

The accessibility widget can make more aggressive DOM optimizations in the second and third examples that specifically accommodate the accessibility client in a way that may be less than ideal for sighted users. By applying these changes, only when the page is accessed by an accessibility client, there is significantly lower risk that the DOM manipulations will negatively impact the typical graphical interface for sighted users. Because of this reduced risk, the accessibility widget can handle a broader number of scenarios.

All of this occurs dynamically, executing directly in the client web browser, and does not require any modifications to vendor code other than to invoke the widget library. Once the web accessibility widget has been executed, a blind user can use a screen reader in all areas where the widget made alterations to the DOM. Properly coded, the widget does not need to impact the user experience of sighted individuals.

As long as the initial call to the widget library can be made, the accessibility widget can operate with any server platform. Although it may be necessary to tailor the widget to fix the problems inherent with a particular platform's inaccessible code, the approach taken is the same for any platform. Because the widget coding is executed directly in the web browser and not on the server, and because of variation between web browsers in their support for JavaScript, deployment of the tailored accessibility widget normally involves compatibility testing of the widget across all supported web browsers. This compatibility testing, for example, typically uses a screen reader or other accessibility application with a web application, which calls the accessibility widget, to determine whether the targeted accessibility problems have been addressed for each of the supported web browsers (e.g., WINDOWS INTERNET EXPLORER 6.0 or above, FIREFOX 2.0 or above, SAFARI 2.0).

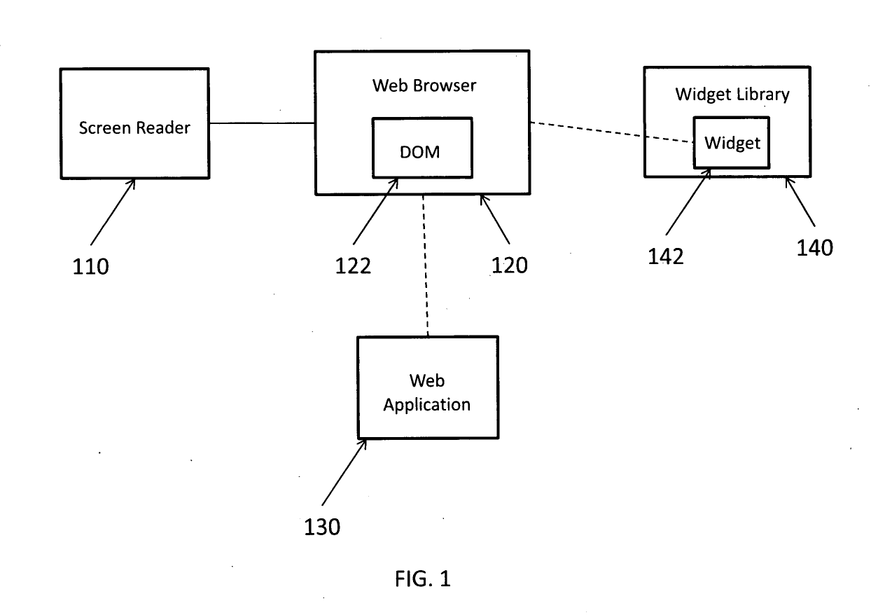

At least one embodiment of the invention provides a system for increasing accessibility of a web application to a screen reader (FIG. 1). The system includes a screen reader 110 connected to a web browser 120, wherein the web browser 120 has a document object model (DOM) 122. At least one web application 130 is accessible by the web browser 120. At least one accessibility widget 142, from a widget library 140, is provided to modify the DOM 122 of the web browser 120.

The system further includes user profile information stored in the web application 130 indicating special accessibility needs for controlling activation of the accessibility widget 142. A cookie is also provided for controlling activation of the accessibility widget 142. The accessibility widget 142 is operable with all server platforms allowing access with a web browser.

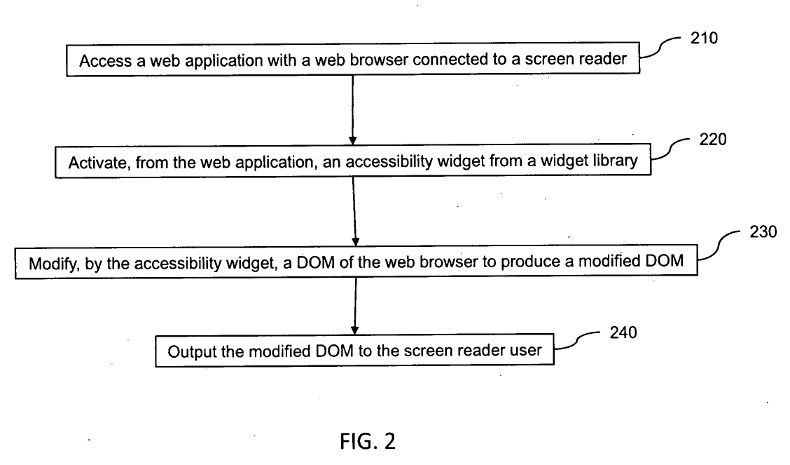

At least one embodiment of the invention provides a method for increasing accessibility of a web application to an accessibility application (e.g., screen reader) (FIG. 2). More specifically, the method accesses at least one web application with a web browser connected to a screen reader (item 210). The method activates, from the web application, at least one accessibility widget from a widget library (item 220). For example, the activation of the accessibility widget is controlled by a cookie and/or user profile information stored in the web application indicating special accessibility needs. In another example, the accessibility widget is activated in response to manual selection of a link, by the screen reader user, that is only viewable using the screen reader.

The method modifies, by the accessibility widget, a document object model (DOM) of the web browser to produce a modified DOM (item 230). An exemplary DOM modification sequence entails loading, by the web browser, the HTML page from the server, the JavaScript library containing the accessibility widget code, and any additional resources required for DOM availability. As the JavaScript library containing the accessibility widget code loads, the library registers an event listener to activate when the DOM representation of the web page becomes available. The DOM representation of the web page becomes available and the web browser triggers the event listener registered by the accessibility widget code. The accessibility widget code accesses the DOM and any other resources necessary to perform the DOM updates. The widget may also register additional event listeners that may trigger additional DOM updates after the initial DOM availability. For example, additional DOM updates may be necessary after an XMLHttpRequest call triggers the insertion of additional DOM elements into the web page. A browser plugin is not required for this DOM manipulation sequence. Moreover, the JavaScript library containing the accessibility widget code does not have to be hosted by the server which provides the HTML page. This is not the only DOM manipulation sequence to which this invention applies.

In an embodiment of the invention, modification of the DOM includes adding objects to the DOM, removing objects in the DOM, and/or modifying properties of objects in the DOM. The objects in the DOM include standard and non-standard objects identified in hypertext markup language (HTML) or extensible markup language (XML) specifications. The standard and non-standard objects include a link, anchor, image, table, caption, button, input, span, division tag, label, head, body, meta, title, paragraph, unordered lists (ul), ordered lists (ol), list items (10, form, heading, and/or extensible metadata platform (XMP).

In another example, the modifying of the DOM includes: modifying HTML attributes (e.g., ALT tags of images) within the web application using pre-configured values or values in title tags, assigning null ALT tags to images within the web application that lack the ALT tags, adding titles readable by the screen reader to frames of the web application, and/or labeling form elements of the web application. In yet another example, the modifying of the DOM includes: replacing malfunctioning screen elements with equivalent screen elements that are accessible with or without the screen reader, adding a skip-to-main-content link, adding cascading style sheets (CSS) adapted to improve accessibility of the screen reader, removing visually hidden objects that impede efficacy of the screen reader, adding table summaries and/or captions, and/or adding anchors and pointers to visually-grouped objects that are not comprehensible by the screen reader user. The modification of the DOM removes the requirement of maintaining a separate version of the web application and/or maintaining a separate version of web pages.

The activating of the accessibility widget renders the web application usable and accessible by the screen reader user while unaffecting users not requiring the screen reader. The modified DOM is output to the screen reader user and/or a rendered web page (for use by the screen reader user) (item 240). The method also dynamically updates at least a portion of the modified DOM, and in response to the updating, repeats the modifying of the DOM.

At least one embodiment of the invention can take the form of an entirely hardware embodiment, an entirely software embodiment or an embodiment including both hardware and software elements. In a preferred embodiment, the invention is implemented in software, which includes but is not limited to firmware, resident software, microcode, etc.

Furthermore, at least one embodiment of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

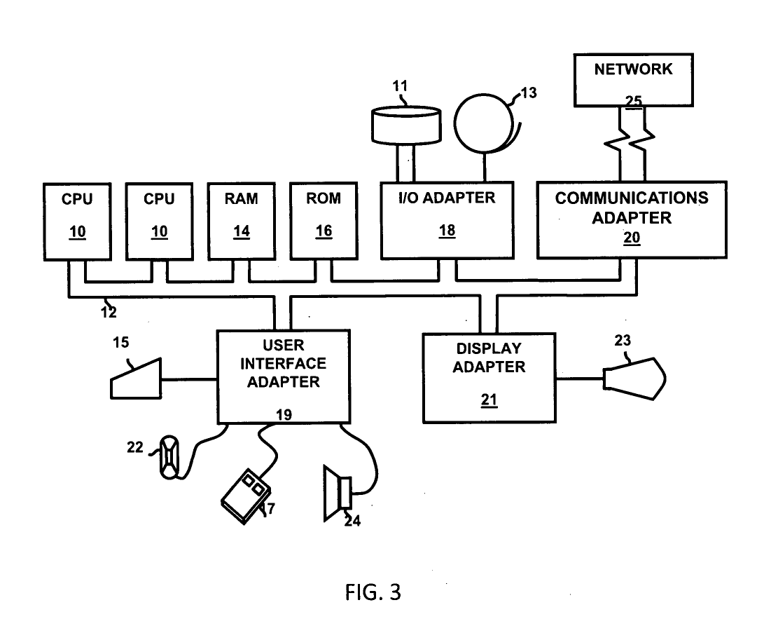

A representative hardware environment for practicing at least one embodiment of the invention is depicted in FIG. 3. This schematic drawing illustrates a hardware configuration of an information handling/computer system in accordance with at least one embodiment of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method for increasing accessibility of a web application to an accessibility application, comprising:
accessing at least one web application with a web browser connected to an accessibility application;
activating, from said web application, at least one accessibility widget from a widget library;
modifying, by said accessibility widget, a document object model (DOM) of said web browser to produce a modified DOM, wherein said modifying includes at least one of
adding objects to said DOM,
removing objects in said DOM, and
modifying properties of objects in said DOM; and
outputting said modified DOM to an accessibility application user.

2. The method according to claim 1, wherein said modifying of said DOM comprises at least one of:
modifying hypertext markup language (HTML) attributes within said web application using one of pre-configured values and values in title tags;
assigning null ALT tags to images within said web application that lack said ALT tags;
adding titles readable by said accessibility application to frames of said web application;
labeling form elements of said web application;
replacing malfunctioning screen elements with equivalent screen elements that are accessible one of with said accessibility application and without said accessibility application;
adding a skip-to-main-content link;
adding cascading style sheets (CSS) adapted to improve accessibility of said accessibility application;
removing visually hidden objects that impede efficacy of said accessibility application;
adding at least one of table summaries and captions; and
adding anchors and pointers to visually-grouped objects that are not comprehensible by said accessibility application user.

3. The method according to claim 1, wherein said activating of said accessibility widget is controlled by at least one of a cookie and user profile information stored in said web application indicating special accessibility needs.

4. The method according to claim 1, wherein said activating of said accessibility widget is performed in response to manual selection of a link, by said accessibility application user, that is only viewable using said accessibility application.

5. The method according to claim 1, wherein said objects in said DOM comprise standard and non-standard objects identified in HTML or extensible markup language (XML) specifications.

6. The method according to claim 5, wherein said standard and non-standard objects comprise at least one of a link, anchor, image, table, caption, button, input, span, division tag, label, head, body, meta, title, paragraph, unordered lists (ul), ordered lists (ol), list items (li), form, heading, and extensible metadata platform (XMP).

7. The method according to claim 1, further comprising
dynamically updating at least a portion of said modified DOM; and
in response to said updating, repeating said modifying of said DOM.

8. The method according to claim 1, wherein said modifying of said DOM comprises removing a requirement of at least one of maintaining a separate version of said web application and maintaining a separate version of web pages.

9. The method according to claim 1, wherein said accessibility application comprises a screen reader.

10. The method according to claim 1, wherein said modifying of said HTML attributes comprises modifying ALT tags of images.

11. A method for increasing accessibility of a web application to a screen reader, comprising:
accessing at least one web application with a web browser connected to a screen reader;
activating, from said web application, at least one accessibility widget from a widget library;
modifying, by said accessibility widget, a document object model (DOM) of said web browser to produce a modified DOM, wherein said modifying includes at least one of
adding objects to said DOM,
removing objects in said DOM, and
modifying properties of objects in said DOM,
wherein said objects in said DOM comprise standard and non-standard objects identified in hypertext markup language (HTML) or extensible markup language (XML) specifications, and
wherein said activating of said accessibility widget comprises:
rendering said web application usable and accessible by said screen reader user, and
unaffecting users not requiring said screen reader; and
outputting said modified DOM to a screen reader user.

12. The method according to claim 11, wherein said modifying of said DOM comprises at least one of:
modifying ALT tags of images within said web application using one of pre-configured values and values in title tags;
assigning null ALT tags to images within said web application that lack said ALT tags;
adding titles readable by said screen reader to frames of said web application;
labeling form elements of said web application;
replacing malfunctioning screen elements with equivalent screen elements that are accessible one of with said screen reader and without said screen reader;
adding a skip-to-main-content link;
adding cascading style sheets (CSS) adapted to improve accessibility of said screen reader;
removing visually hidden objects that impede efficacy of said screen reader;
adding at least one of table summaries and captions; and
adding anchors and pointers to visually-grouped objects that are not comprehensible by said screen reader user.

13. The method according to claim 11, wherein said activating of said accessibility widget is controlled by at least one of a cookie and user profile information stored in said web application indicating special accessibility needs.

14. The method according to claim 11, wherein said activating of said accessibility widget is performed in response to manual selection of a link, by said screen reader user, that is only viewable using said screen reader.

15. The method according to claim 11, wherein said standard and non-standard objects comprise at least one of a link, anchor, image, table, caption, button, input, span, division tag, label, head, body, meta, title, paragraph, unordered lists (ul), ordered lists (ol), list items (li), form, heading, and extensible metadata platform (XMP).

16. The method according to claim 11, further comprising
dynamically updating at least a portion of said modified DOM; and
in response to said updating, repeating said modifying of said DOM.

17. The method according to claim 11, wherein said modifying of said DOM comprises removing a requirement of at least one of maintaining a separate version of said web application and maintaining a separate version of web pages.

18. A system for increasing accessibility of a web application to a screen reader, comprising:
a screen reader connected to a web browser, said web browser having a document object model (DOM);
at least one web application accessible by said web browser; and
at least one accessibility widget, from a widget library, adapted to modify said DOM of said web browser.

19. The system according to claim 18, further comprising user profile information stored in said web application indicating special accessibility needs for controlling activation of said accessibility widget.

20. The system according to claim 18, further comprising a cookie for controlling activation of said accessibility widget.

21. The system according to claim 18, wherein said accessibility widget is operable with all server platforms allowing access with a web browser.

22. A computer program product comprising computer readable program code stored on computer readable storage medium embodied therein for performing a method for increasing accessibility of a web application to a screen reader, said method comprising:
accessing at least one web application with a web browser connected to a screen reader;
activating, from said web application, at least one accessibility widget from a widget library;
modifying, by said accessibility widget, a document object model (DOM) of said web browser to produce a modified DOM, wherein said modifying includes at least one of
adding objects to said DOM,
removing objects in said DOM, and
modifying properties of objects in said DOM,
wherein said objects in said DOM comprise standard and non-standard objects identified in hypertext markup language (HTML) or extensible markup language (XML) specifications, and
wherein said activating of said accessibility widget comprises:
rendering said web application usable and accessible by said screen reader user, and
unaffecting users not requiring said screen reader; and
outputting said modified DOM to a screen reader user.

23. The method according to claim 22, wherein said modifying of said DOM comprises at least one of:
modifying ALT tags of images within said web application using one of pre-configured values and values in title tags;
assigning null ALT tags to images within said web application that lack said ALT tags;
adding titles readable by said screen reader to frames of said web application;
labelling form elements of said web application;
replacing malfunctioning screen elements with equivalent screen elements that are accessible one of with said screen reader and without said screen reader;
adding a skip-to-main-content link;
adding cascading style sheets (CSS) adapted to improve accessibility of said screen reader;
removing visually hidden objects that impede efficacy of said screen reader;
adding at least one of table summaries and captions; and
adding anchors and pointers to visually-grouped objects that are not comprehensible by said screen reader user.

24. The method according to claim 22, wherein said activating of said accessibility widget is controlled by at least one of a cookie and user profile information stored in said web application indicating special accessibility needs.

25. The method according to claim 22, wherein said activating of said accessibility widget is performed in response to manual selection of a link, by said screen reader user, that is only viewable using said screen reader.
